(19) United States
(12) Patent Application Publication
(10) Pub. No.: US 2016/0174269 A1
(43) Pub. Date: Jun. 16, 2016

(54) Methods and Apparatus for Device to Device Communication

(71) Applicant: NOKIA TECHNOLOIES OY, Espoo (FI)

(72) Inventors: Yixue LEI, Beijing (CN); Zhi ZHANG, Beijing (CN); Zexian LI, Espoo (FI); Juejia ZHOU, Beijing (CN)

(21) Appl. No.: 14/904,805

(22) PCT Filed: Jul. 31, 2013
(86) PCT No.: PCT/CN2013/080499

§ 371 Date: Jan. 13, 2016

(51) Int. Cl. H04W 76/02; H04W 48/16

(52) U.S. Cl. CPC H04W 76/02; H04W 48/16

(57) ABSTRACT

Systems and techniques for managing collisions in discovery of device to device communication capable devices. Depending on whether collision probability is high or low, collision avoidance, or collision detection, may be performed. In collision avoidance, a user device broadcasting a discovery signal includes a cell identifier with the signal. In collision detection, a user device is allocated with an identifying sequence unique to a serving cell. A discovering user device's base station sends a report including a sequence associated with a discovered device to a core network element, which has information relating to sequences and cells of each user device. The network element examines information for neighboring cells of the discovering user device's serving cell and determines if the same identifying sequence associated with the discovered user device is associated with one or more user devices served by neighbor cells to the serving cell of the discovering user device.

### TECHNICAL FIELD

The present invention relates generally to wireless communication. More particularly, the invention relates to device to device communication between wireless devices.

### BACKGROUND

Device to device communication is gaining more and more interest among wireless communication users and operators, and one approach that has gained particular interest is the use of proximity based services (ProSe), and the use of such services involves proximity based discovery. One device may transmit a beacon which can be detected by other devices, with devices that are within range being able to identify one another and engage in communication if appropriate. A device transmits a beacon that can be identified by a particular sequence—for example, a sequence that is globally unique in one public land mobile network (PLMN)—that is, it is not repeated among the various base stations used in the network (such as macro evolved node Bs (eNBs) in the case of a network operating as defined by third generation partnership project (3GPP). In other cases, the sequence transmitted by the device may be unique only for one macro (eNB). By identifying the sequence, an eNB can determine which user equipment (UE) is represented by the sequence. In different network, UE, or eNB configurations, different discovery beacon configurations may be used. A discovery beacon may, for example, include only sequence information, or it may include both sequence information and a UE-specific higher layer identifier such as a global unique temporary identifier (GUTI)/SAE temporary mobile subscriber identity (S-TMSI)/M-TMSI—that is, GUTI/S-TMSI/M-TMSI.

### SUMMARY

In one embodiment of the invention, an apparatus comprises at least one processor and memory storing a program of instructions. The memory storing the program of instructions is configured to, with the at least one processor, cause the apparatus to at least, in response to receiving a discovery report originating at a discovering user device, wherein the discovery report includes an identifying sequence from a discovering user device, send, to a core network element, discovery information including an identifier of the discovered device and receive a notification from the core network element indicating whether the discovery report represents a collision. The notification is based on examination of one or more neighbor cells to a cell serving the discovering user device, and a collision is indicated if at least an identical identifying sequence to that of the discovered device is present in at least one of the one or more neighbor cells

In another embodiment of the invention, an apparatus comprises at least one processor and memory storing a program of instructions. The memory storing the program of instructions is configured to, with the at least one processor, cause the apparatus to at least, in response to receiving discovery report information from a base station serving a discovering user device, wherein the discovery report includes an identifying sequence of a discovered user device detected by the discovering user device, examine information for cells neighboring the serving base station of the discovering user device to determine if one or more neighbor cells are associated with an identifying sequence identical to that of the discovered user device and, if one or more neighbor cells are associated with an identifying sequence identical to that of the discovered user device, determine that discovery of the discovered user device has been affected by a collision.

In another embodiment of the invention, an apparatus comprises at least one processor and memory storing a program of instructions. The memory storing the program of instructions is configured to, with the at least one processor, cause the apparatus to at least control a user device to broadcast a discovery signal comprising an identifying sequence unique among user devices served by a base station, the identifying sequence being configured to the user device by its serving base station and having a specified period of validity, and being configured to cause the base station, upon receiving a forwarded discovery report including the identifying sequence within its period of validity, to authorize forwarding of the discovery report to a core network entity for collision detection.

In another embodiment of the invention, an apparatus comprises at least one processor and memory storing a program of instructions. The memory storing the program of instructions is configured to, with the at least one processor, cause the apparatus to at least control a discovering user device to, upon receiving a discovery beacon from a discovered user device, wherein the discovery beacon comprises an identifying sequence configured to its serving device, wherein the identifying sequence has a specified period of validity, forward a discovery report to a serving base station of the discovering user device. The discovery report is configured to cause the discovering device's serving base station to forward the discovery report to a core network element which determines whether a collision has occurred based on detection of the identifying sequence in neighboring cells of the serving base station of the discovered user device.

In another embodiment of the invention, an apparatus comprises at least one processor and memory storing a program of instructions. The memory storing the program of instructions is configured to, with the at least one processor, cause the apparatus to at least control a first base station serving a discovering user device to receive a discovery report comprising an identifying sequence and physical cell identity of a discovered user device, control the first base station to forward the discovery report to a second base station serving a discovered user device, and, in response to receiving from the second base station a discovery acknowledgement, forwarding the discovery acknowledgement to the discovered user device.

In another embodiment of the invention, a method comprises, in response to receiving a discovery report originating at a discovering user device, wherein the discovery report includes an identifying sequence from a discovering user device, sending, to a core network element, discovery information including an identifier of the discovered device and receiving a notification from the core network element indicating whether the discovery report represents a collision. The notification is based on examination of one or more neighbor cells to a cell serving the discovering user device, and a collision is indicated if at least an identical identifying sequence to that of the discovered device is present in at least one of the one or more neighbor cells.

In another embodiment of the invention, a method comprises, in response to receiving discovery report information from a base station serving a discovering user device, wherein the discovery report includes an identifying sequence of a discovered user device detected by the discovering user device, examining information for cells neighboring the serving base station of the discovering user device to determine if one or more neighbor cells are associated with an identifying sequence identical to that of the discovered user device and, if one or more neighbor cells are associated with an identifying sequence identical to that of the discovered user device, determining that discovery of the discovered user device has been affected by a collision.

In another embodiment of the invention, a method comprises controlling a user device to broadcast a discovery signal comprising an identifying sequence unique among user devices served by a base station, the identifying sequence being configured to the user device by its serving base station and having a specified period of validity, and being configured to cause the base station, upon receiving a forwarded discovery report including the identifying sequence within its period of validity, to authorize forwarding of the discovery report to a core network entity for collision detection.

In another embodiment of the invention, a method comprises controlling a discovering user device to, upon receiving a discovery beacon from a discovered user device, wherein the discovery beacon comprises an identifying sequence configured to its serving device, wherein the identifying sequence has a specified period of validity, forward a discovery report to a serving base station of the discovering user device. The discovery report is configured to cause the discovering device's serving base station to forward the discovery report to a core network element which determines whether a collision has occurred based on detection of the identifying sequence in neighboring cells of the serving base station of the discovered user device.

In another embodiment of the invention, a method comprises controlling a first base station serving a discovering user device to receive a discovery report comprising an identifying sequence and physical cell identity of a discovered user device, control the first base station to forward the discovery report to a second base station serving a discovered user device, and, in response to receiving from the second base station a discovery acknowledgement, forwarding the discovery acknowledgement to the discovered user device.

In another embodiment of the invention, a computer readable medium stores a program of instructions. Execution of the program of instructions by a processor configures an apparatus to at least, in response to receiving a discovery report originating at a discovering user device, wherein the discovery report includes an identifying sequence from a discovering user device, send, to a core network element, discovery information including an identifier of the discovered device and receive a notification from the core network element indicating whether the discovery report represents a collision. The notification is based on examination of one or more neighbor cells to a cell serving the discovering user device, and a collision is indicated if at least an identical identifying sequence to that of the discovered device is present in at least one of the one or more neighbor cells.

In another embodiment of the invention, the identifying sequence is allocated to a discovered user device by a serving base station of the discovered user device and wherein allocation comprises assigning a period of validity to the sequence, and wherein the discovery information is sent to the core network element only upon confirmation from the base station serving the discovered user device that the base station has allocated the reported sequence to a user device during its period of validity.

In another embodiment of the invention, the identifying sequence of the discovered user device is allocated to the discovered user device by its serving base station.

In another embodiment of the invention, each serving base station allocating an identifying sequence of a user device provides to the core network entity information relating to the identifying sequence.

In another embodiment of the invention, the core network element is a mobility management entity.

In another embodiment of the invention, the discovery information is sent to the core network entity over an S1 connection.

In another embodiment of the invention, a computer readable medium stores a program of instructions. Execution of the program of instructions by a processor configures an apparatus to at least, in response to receiving discovery report information from a base station serving a discovering user device, wherein the discovery report includes an identifying sequence of a discovered user device detected by the discovering user device, examine information for cells neighboring the serving base station of the discovering user device to determine if one or more neighbor cells are associated with an identifying sequence identical to that of the discovered user device and, if one or more neighbor cells are associated with an identifying sequence identical to that of the discovered user device, determine that discovery of the discovered user device has been affected by a collision.

In another embodiment of the invention, the apparatus is further configured to reallocate a new identifying sequence to the discovered user device if it is determined that discovery of the discovered user device has been affected by a collision.

In another embodiment of the invention, the identifying sequence of the discovered user device comprises a period of validity assigned by the serving base station of the discovered user device and wherein the discovery information is received only if discovery occurs during the period of validity of the sequence.

In another embodiment of the invention, a computer readable medium stores a program of instructions. Execution of the program of instructions by a processor configures an apparatus to at least control a user device to broadcast a discovery signal comprising an identifying sequence unique among user devices served by a base station, the identifying sequence being configured to the user device by its serving base station and having a specified period of validity, and being configured to cause the base station, upon receiving a forwarded discovery report including the identifying sequence within its period of validity, to authorize forwarding of the discovery report to a core network entity for collision detection.

In another embodiment of the invention, an apparatus comprises at least one processor and memory storing a program of instructions. The memory storing the program of instructions is configured to, with the at least one processor, cause the apparatus to at least control a discovering user device to, upon receiving a discovery beacon from a discovered user device, wherein the discovery beacon comprises an identifying sequence configured to its serving device, wherein the identifying sequence has a specified period of validity, forward a discovery report to a serving base station of the discovering user device. The discovery report is configured to cause the discovering device's serving base station to forward the discovery report to a core network element which determines whether a collision has occurred based on detection of the identifying sequence in neighboring cells of the serving base station of the discovered user device.

In another embodiment of the invention, the discovery report is configured to cause the discovering device's serving base station to forward the discovery report only upon receiving an instruction from the discovered device's serving base station, wherein instruction is sent in response to confirmation by the discovered device's serving base station that the base station has configured the identifying sequence within the validity period.

In another embodiment of the invention, a computer readable medium stores a program of instructions. Execution of the program of instructions by a processor configures an apparatus to at least control a first base station serving a discovering user device to receive a discovery report comprising an identifying sequence and physical cell identity of a discovered user device, control the first base station to forward the discovery report to a second base station serving a discovered user device, and, in response to receiving from the second base station a discovery acknowledgement, forwarding the discovery acknowledgement to the discovered user device.

In another embodiment of the invention, forwarding the discovery report, receiving the discovery acknowledgement, and forwarding the discovery acknowledgement are accomplished using X2 messaging.

In another embodiment of the invention, an apparatus comprises means for, in response to receiving a discovery report originating at a discovering user device, wherein the discovery report includes an identifying sequence from a discovering user device, send, to a core network element, discovery information including an identifier of the discovered device and means for receiving a notification from the core network element indicating whether the discovery report represents a collision, wherein the notification is based on examination of one or more neighbor cells to a cell serving the discovering user device, and wherein a collision is indicated if at least an identical identifying sequence to that of the discovered device is present in at least one of the one or more neighbor cells.

In another embodiment of the invention, an apparatus comprises means for, in response to receiving discovery report information from a base station serving a discovering user device, wherein the discovery report includes an identifying sequence of a discovered user device detected by the discovering user device, examining information for cells neighboring the serving base station of the discovering user device to determine if one or more neighbor cells are associated with an identifying sequence identical to that of the discovered user device and, if one or more neighbor cells are associated with an identifying sequence identical to that of the discovered user device, determining that discovery of the discovered user device has been affected by a collision.

In another embodiment of the invention, an apparatus comprises means for controlling a user device to broadcast a discovery signal comprising an identifying sequence unique among user devices served by a base station, the identifying sequence being configured to the user device by its serving base station and having a specified period of validity, and being configured to cause the base station, upon receiving a forwarded discovery report including the identifying sequence within its period of validity, to authorize forwarding of the discovery report to a core network entity for collision detection.

In another embodiment of the invention, an apparatus comprises means for controlling a discovering user device to, upon receiving a discovery beacon from a discovered user device, wherein the discovery beacon comprises an identifying sequence configured to its serving device, wherein the identifying sequence has a specified period of validity, forward a discovery report to a serving base station of the discovering user device. The discovery report is configured to cause the discovering device's serving base station to forward the discovery report to a core network element which determines whether a collision has occurred based on detection of the identifying sequence in neighboring cells of the serving base station of the discovered user device.

In another embodiment of the invention, an apparatus comprises means for controlling a first base station serving a discovering user device to receive a discovery report comprising an identifying sequence and physical cell identity of a discovered user device, means for controlling the first base station to forward the discovery report to a second base station serving a discovered user device, and means for, in response to receiving from the second base station a discovery acknowledgement, forwarding the discovery acknowledgement to the discovered user device.

### BRIEF DESCRIPTION OF THE DRAWINGS

FIG. 1 illustrates a network operating according to an embodiment of the present invention;

FIG. 2 illustrates a process according to an embodiment of the present invention;

FIG. 3 illustrates elements and operations performed according to an embodiment of the present invention;

FIG. 4 illustrates a process according to an embodiment of the present invention;

FIG. 5 illustrates elements and operations performed according to another embodiment of the present invention;

FIG. 6 illustrates a process according to an embodiment of the present invention; and

FIG. 7 illustrates elements for carrying out an embodiment of the present invention.

### DETAILED DESCRIPTION

Embodiments of the invention recognize that difficulties can arise in identifying UEs based on discovery beacons when a sequence is not unique for UEs across a cellular network, so that a UE has a sequence that is unique under only one serving eNB when it is in connected mode. Such a lack of uniqueness gives rise to a possibility of collision during ProSe discovery for UEs under different serving eNBs or cells, especially at a cell edge. Embodiments of the present invention predict collision probability based on factors such as potential UE density and cell topology, and make decisions about whether to enhance the discovery beacon to avoid collision based on whether the collision probability is high or low. If collision probability is low, collisions may simply be allowed to occur and then detected once they do occur (such as by discovery failure), with the network then being triggered to reallocate the sequence. Managing of sequences so that they are unique among only a single serving cell avoids a need to broadcast information such as a globally unique UE identifier such as GUTI, which is quite long and whose length may exceed the maximum number of bits allowed for physical layer discovery channel design.

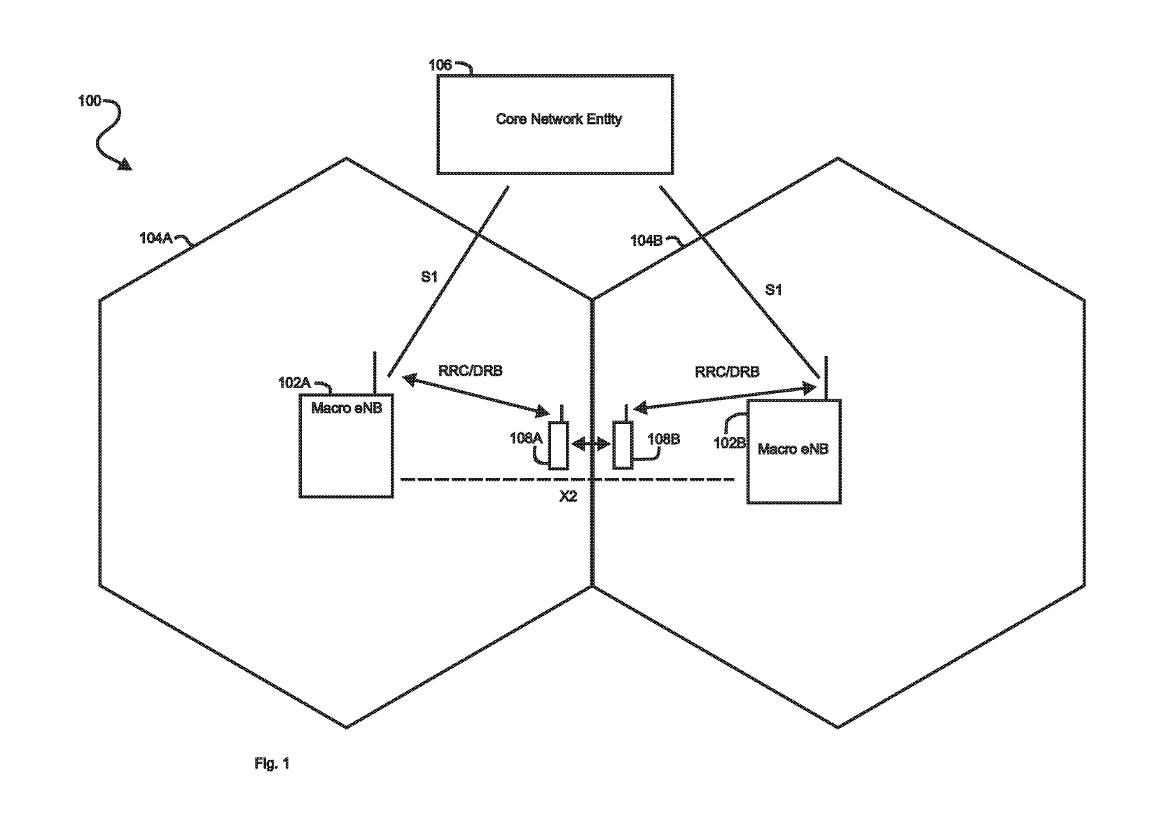

FIG. 1 illustrates a cellular wireless network 100, comprising base stations suitably implemented as eNBs 102A and 102B, defining cells 104A and 104B, respectively. The eNBs 102A and 102B suitably communicate with one another over an X2 connection and also communicate through S1 connections with a core network entity such as a core network entity (CN) 106 The core network entity may include elements such as a mobility management entity (MME). The eNB 102A serves a UE 108A and the eNB 102B serves a UE 108B, with each of the eNBs serving its UE through RRC in the control plane and DRB in the user plane. The UE 108A and 108B are device to device capable UE and in the present exemplary case are configured to perform proximity based services (ProSe) discovery.

If the collision rate is low, the network 100 or an eNB such as the eNBs 102A or 102B allows collisions to happen and deals with them through collision detection and resolution. This allows for the configuration of a discovery signal or discovery message without a need to associate serving cell information such as physical cell identity (PCI) with a discovery signal or contain such information in a discovery message.

To detect collisions, an eNB may allocate a timer for a UE when allocating a sequence for a connected mode UE. The timer can be used to allow the eNB to detect a potential collision when a discovering UE reports a detected sequence. The eNB may configure the timer for the UE using radio resource control (RRC) signaling.

Upon allocation of the sequence, the UE reports to a network entity such as an MME or DRSF the sequence associated with UEs to be discovered (that is, the sequence that has been allocated by the eNB). This core network entity is made aware of the allocated sequence of all UEs (both discovering and discovered) under different cells. Such D2D discovery related information is maintained in the core network entity for collision detection. UE context information is also maintained in the core network entity.

If the collision rate is high, a collision avoidance approach may be adopted. Such collision avoidance uses, for example, PCI information associated with a discovery signal or contained in a discovery message. Inter-eNB coordination may be conducted to support ProSe discovery in multiple cells.

As noted above, the determination as to whether to manage collisions through collision detection or collision avoidance is based on collision probability. The collision policy threshold at which the probability is sufficiently high as to call for collision avoidance may be set as part of an operator's policy and configuration, or extended SON/MDT approach by taking collision probability as a performance indicator for statistics and optimization.

For a complete ProSe discovery procedure according to one or more embodiments of the present invention, after the discovering UE acquires the UE identifier which is unique only in one serving cell and also determines the serving cell of the discovered UE, signaling interaction over S1 or X2 interface is performed, as shown in FIG. 1.

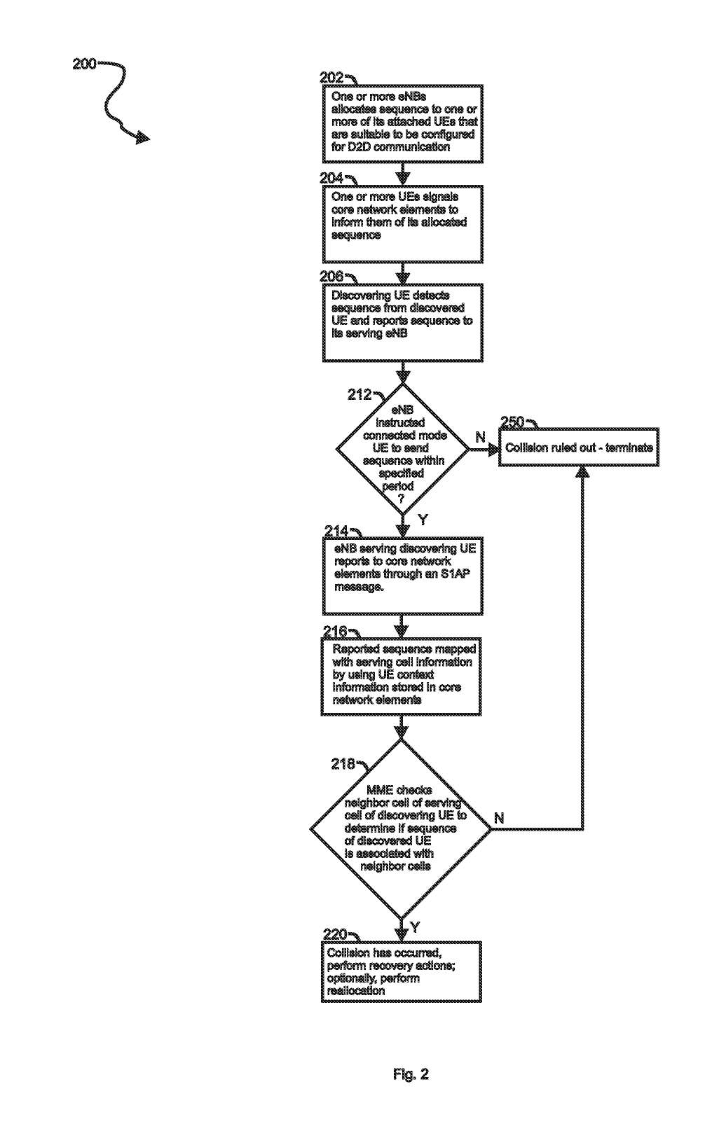

FIG. 2 illustrates a process 200 of collision detection according to an embodiment of the present invention. The process 200 may be performed, for example, by devices such as the eNB 102A, eNB 102B, CORE NETWORK ENTITY 106, UE 108A, and UE 108B. In the present example the UE 108A is seeking a UE and the UE 108B is broadcasting an identifier to make itself discoverable.

At block 202, one or more eNBs allocates a sequence to one or more attached UE that may be configured for device to device communication, with each allocated sequence associated with an UE being unique within the cell served by the eNB. A timer expiration value may also be configured by the eNB 102B as it allocates a sequence to a UE such as the UE 108B, in order to manage the change of sequences during ProSe discovery in both single cell and multiple cell scenarios. Configuration of the timer expiration value for the UE 108B may be performed via RRC signaling.

At block 204, one or more UEs having an allocated sequence signals core network elements, such as an MME, to inform them of its allocated sequence. These sequences are stored by the MME together with UE context information. The signaling may be accomplished through radio resource control (RRC) communication with each UE's serving eNB, and from each eNB to the MME through S1 connections.

At block 206, a discovering UE, such as the UE 108A, detects a sequence from a discovered UE, such as the 108B, and reports the sequence to its serving eNB 102A. At block 212, the eNB 102B determines whether it has instructed a connected mode UE to send the sequence within a specified preceding time period. If not, the sequence is from a neighboring eNB and no collision has occurred, so that the process ends at block 250. If yes, the process continues at block 214.

At block 214, the eNB serving the discovering UE reports to the core network elements through an S1AP message. The discovering UE's S1AP UE ID and the reported sequence of the discovered UE are reported to the MME 106.

At block 216, the reported sequence is mapped with serving cell information by using UE context information stored in the core network elements 106—specifically the MME. Next, at block 218, the MME checks the neighbor cells of the serving cell of the discovering UE to determine if the reported sequence of the discovered UE is associated with the neighbor cells. If no, the process terminates at block 250 because no collision has occurred.

If yes, the process proceeds to block 220 and a collision is determined to have occurred. The sequence may be optionally be reallocated. According to one or more embodiments of the invention, such reallocation is optional.

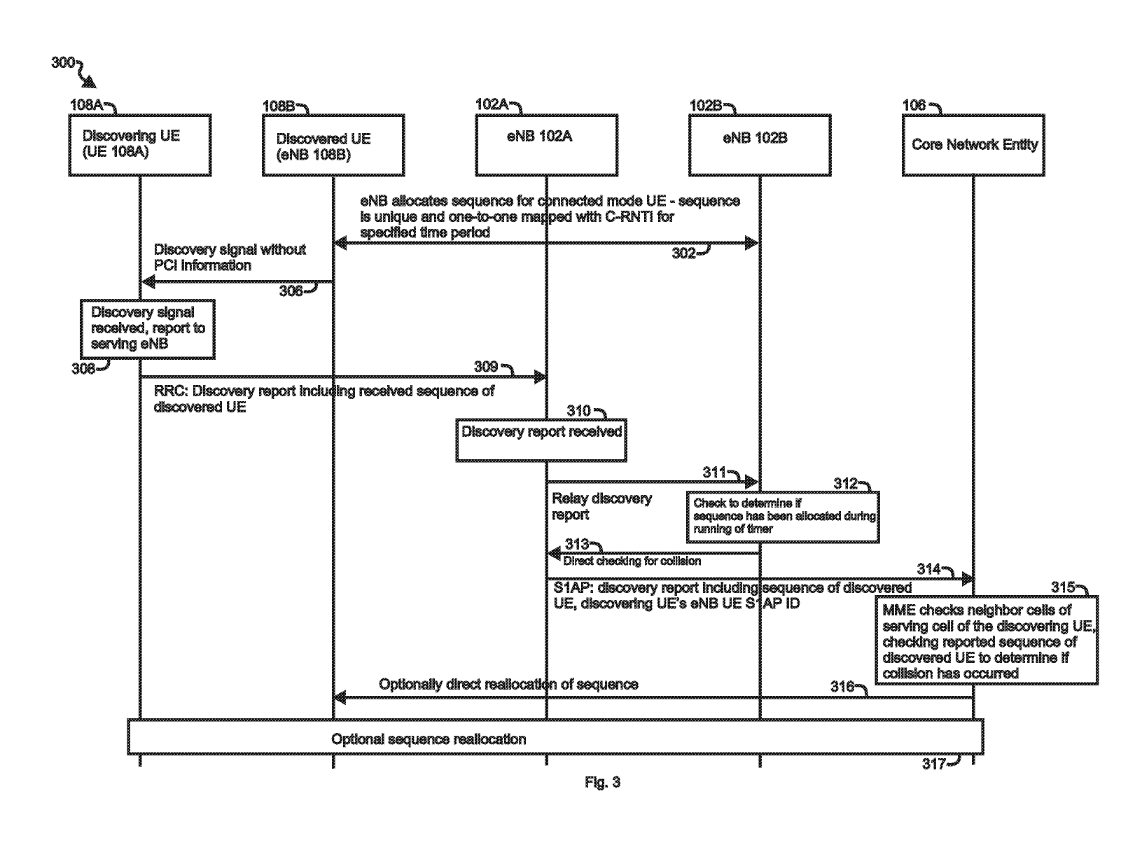

FIG. 3 illustrates a diagram 300 showing operations of and interactions between elements of a network such as the network 100 operating according to an embodiment of the present invention. In the present example, various processes illustrated in FIG. 3 and discussed here may be carried out by, and involve communications between, the discovering UE 108A, the discovered UE 108B, the eNB 102A, the eNB 102B, and the CORE NETWORK ENTITY 106. In the present example, the collision probability has been determined to be low and the network elements illustrated in FIG. 3 and discussed below have been configured to detect and manage collisions if they occur.

Each UE transmits a discovery signal to allow for discovery, such as a beacon including an identifying sequence. In the present example, the eNB 102B performs allocation 302 of a sequence for its connected mode UE 108B, which is unique and can be one-to-one mapped with the cell-radio network temporary identifier (C-RNTI) for a specified time period.

The discovering UE 108A detects a discovery signal 306 from the discovered UE 108B. The discovery signal does not include PCI information and is not necessarily unique throughout the entire network. The discovering UE 108A performs reporting 308 to its serving eNB 102A, sending a discovery report signal 309, including the received sequence of the discovered UE. Upon receiving the report signal 309, the eNB 102A relays the discovery report to the eNB 102B in a signal 311. The eNB 102B performs a check 312 to determine if the sequence has been allocated during running of a timer set to a validity period of a sequence. Allocation of such a sequence indicates that the potential exists for a collision, but if no such sequence has been allocated by the eNB 102B, there is no need to do further checking because the sequence did not originate at the eNB 102B or a UE served by the eNB 102B. If a sequence has been allocated, the eNB 102B sends a signal 313 to the eNB 102A, directing checking for a collision. The eNB 102A sends a discovery report 314 including the sequence of the discovered UE (108B) and the S1 application protocol identifier (S1AP ID) of the discovering UE (108A). The core network entity 106 performs a check 315, checking cells neighboring the serving cell of the discovering UE, as well as the reported sequence of the discovered UE, in order to determine if a collision is present. Optionally, the core network entity 106 may send a command signal 316 to the discovered UE (108B) directing reallocation of the sequence. The various elements (UEs 108A and 108B, eNBs 102A and 102B, and core network entity 106) perform information exchange 317 to perform the optional sequence reallocation.

If collision probability is determined to be high—for example, if the probability is over a threshold specified as part of an operator's policy and configuration for a network such as the network 100, the network may use collision avoidance, uniquely identifying each UE. If a UE's sequence is unique for its serving cell, then a serving cell PCI associated with discovery signal, together with the UE's sequence, will serve to uniquely identify the UE. If the discovered UE is served by a different eNB than is the discovering UE, the serving eNB of the discovering UE may use PCI information to identify the serving cell of the discovered UE, using a neighbor relation table for the neighboring cells. Inter eNB signaling exchanges may then be carried out to perform the discovery process. In an X2 message from the serving eNB of the discovering UE to the serving eNB of the discovered UE, the following information may be included: the reported sequence of the discovered UE; serving cell PCI and/or E-CGI of discovered UE. The discovered UE's cell radio network temporary identifier (C-RNTI) may be delivered in another X2 message from the serving eNB of discovered UE to the serving eNB of discovering UE. These information exchanges can uniquely identify the discovered UE to the discovering UE, and this identification can be used for ProSe applications and also to trigger establishment of a ProSe communication path.

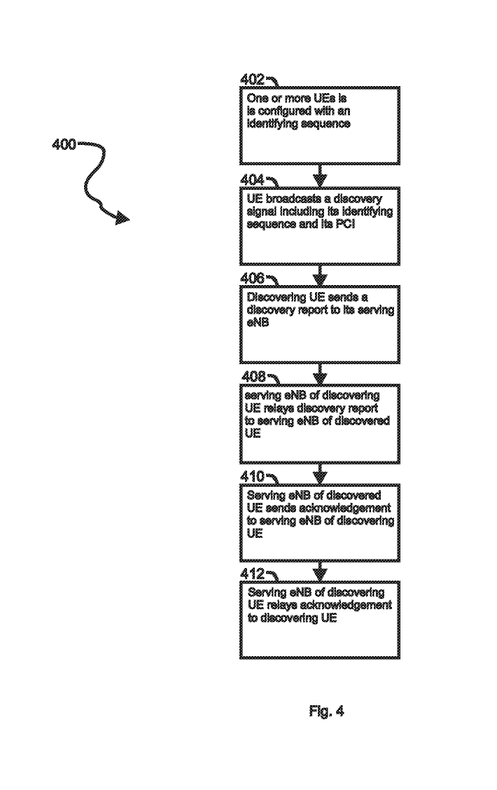

FIG. 4 illustrates a process 400 according to an embodiment of the present invention. FIG. 4 illustrates the process 400 as connected blocks, and in one or more embodiments, such blocks may represent steps of a method.

At block 402, one or more UEs configurable to operate in D2D communication are each configured with an identifying sequence that is unique among UEs served by a particular eNB. At block 404, a UE such as the UE 102B broadcasts a discovery signal including its identifying sequence and its PCI. At block 406, a discovering UE such as the UE 102 sends a discovery report to its serving eNB. At block 408, the serving eNB relays the discovering report to the discovered UE's serving eNB—for example, the serving eNB 102B of the discovering UE 108B. At block 410, the serving eNB of the discovered UE sends an acknowledgement to the serving eNB of the discovering UE, and at block 412, the serving eNB of the discovering UE relays the acknowledgement to the discovering UE.

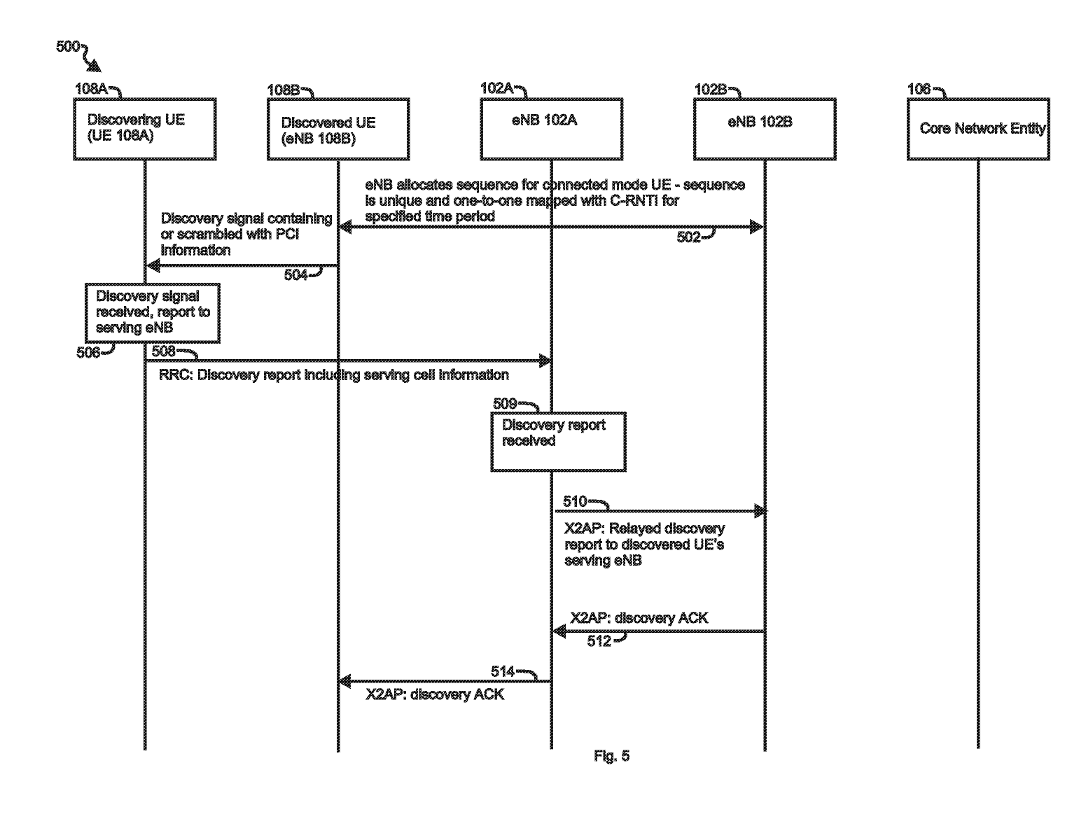

FIG. 5 illustrates a diagram 500 showing operations of and interactions between elements of a network such as the network 100 operating according to an embodiment of the present invention. Various processes illustrated in FIG. 5 and discussed here by way of example may be carried out by, and involve communications between, the discovering UE 108A, the discovered UE 108B, the eNB 102A, the eNB 102B, and the CORE NETWORK ENTITY 106. In the present example, a determination has been made that the probability of a collision is high, and the network 100 has been configured to uniquely identify devices that are to engage in device to device communication when there is a high probability of a collision.

The serving eNB (102B) for the discovered UE (108B) performs an identifier allocation 502, allocating a sequence for the UE 108B and, suitably, other connected mode UEs. The sequence is unique among the UEs being served by the eNB 102B. The eNB 102B may also configure the UE 108B to maintain the PCI information associated with the eNB 102B. The discovered UE (108B) broadcasts a discovery signal 504 detected by a discovering UE (108A). The discovery signal 504 may include the sequence allocated to the discovered UE as well as the PCI information for the discovered UE's serving eNB. In one or more embodiments of the invention, the PCI information may be scrambled with the sequence information or other information in the discovery signal.

The discovering UE 108A performs a discovery signal receiving process 506, including preparing a report to its serving eNB (102A). The discovering UE 108A sends a discovery report 508, including serving cell information. The serving eNB (102A) upon receiving the discovery report at 509, sends a first X2AP message 510 to the eNB 102B, relaying the discovery report to the eNB 102B, which is the serving eNB of the discovered UE 108B. The eNB 102B sends a second X2AP message 512 to the eNB 102A, delivering an acknowledgement of the discovery report to the eNB 102A. The eNB 102A sends a third X2AP message 514 to the UE 108B, delivering an acknowledgement of the discovery report to the UE 108B. The discovering UE 108A and the discovered UE 108B are then able to perform device to device communication with the understanding that the discovered UE 108B has been uniquely identified to the discovering UE 108A.

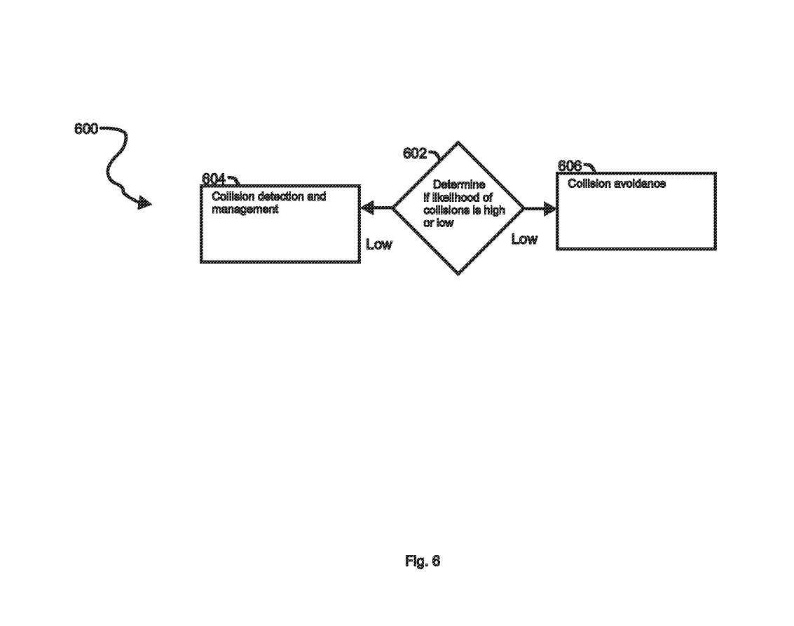

FIG. 6 illustrates a process 600 of collision management according to an embodiment of the present invention. At block 602, a determination is made as to whether the likelihood of collisions affecting D2D device discovery is high or low—for example, of the probability of collisions is above a specified threshold. If the likelihood is determined to be low, the process proceeds to block 604, and collision detection and management are performed—for example, using mechanisms similar to those depicted in FIGS. 2 and 3 and described in connection therewith, in which D2D devices are uniquely identified with respect to the cell but not with respect to the network as a whole. If the likelihood is determined to be high, the process proceeds to block 606, and collision is prevention is performed—for example, using mechanisms similar to those depicted in FIGS. 4 and 5 and described in connection therewith, in which D2D devices are uniquely identified with respect to the network, for example by configuring each D2D device with an identifier unique to the cell to which it is attached and associating the identifier with a cell identifier.

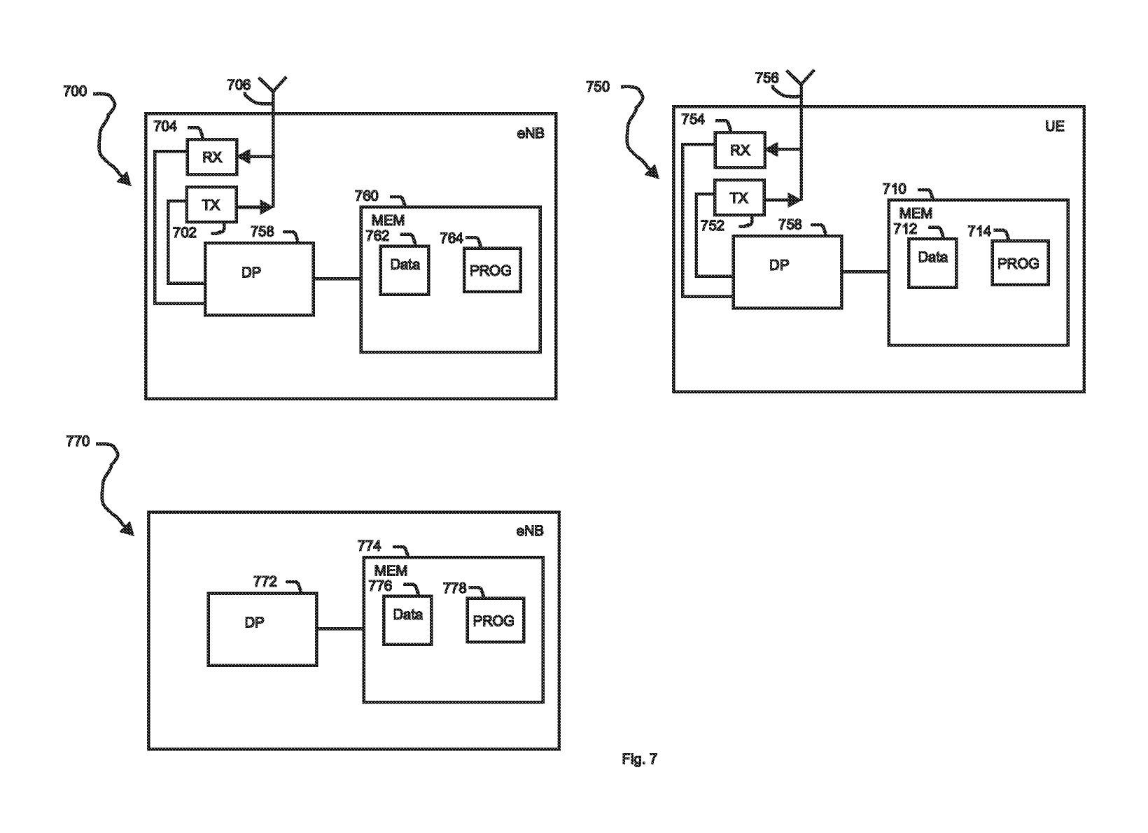

FIG. 7 illustrates details of a base station, implemented as an eNB 700, and a mobile communications device, implemented as a UE 750. The eNB 700 may suitably comprise a transmitter 702, receiver 704, and antenna 706. The eNB 700 may also include a processor 708 and memory 710. The eNB 700 may employ data 712 and programs (PROGS) 714, residing in memory 710.

The eNB 750 may suitably comprise a transmitter 752, receiver 754, and antenna 756. The eNB 750 may also include a processor 758 and memory 760. The eNB 750 may employ data 762 and programs (PROGS) 764, residing in memory 760.

At least one of the PROGs 714 in the eNB 700 is assumed to include a set of program instructions that, when executed by the associated DP 708, enable the device to operate in accordance with the exemplary embodiments of this invention, as detailed above. In these regards the exemplary embodiments of this invention may be implemented at least in part by computer software stored on the MEM 710, which is executable by the DP 708 of the eNB 700, or by hardware, or by a combination of tangibly stored software and hardware (and tangibly stored firmware). Similarly, at least one of the PROGs 764 in the eNB 750 is assumed to include a set of program instructions that, when executed by the associated DP 758, enable the device to operate in accordance with the exemplary embodiments of this invention, as detailed above. In these regards the exemplary embodiments of this invention may be implemented at least in part by computer software stored on the MEM 760, which is executable by the DP 758 of the eNB 750, or by hardware, or by a combination of tangibly stored software and hardware (and tangibly stored firmware). Electronic devices implementing these aspects of the invention need not be the entire devices as depicted at FIG. 1 or FIG. 6 or may be one or more components of same such as the above described tangibly stored software, hardware, firmware and DP, or a system on a chip SOC or an application specific integrated circuit ASIC.

In general, the various embodiments of the UE 750 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 710 and 760 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 08 and 758 include but are not limited to general purpose computers, special purpose computers, microprocessors, digital signal processors (DSPs) and multi-core processors.

FIG. 7 also illustrates a core network element 770, which may, for example, include elements such as an MME. The core network element 770 may suitably comprise a processor 772 and memory 774. The core network element 770 may employ data 776 and programs (PROGS) 778, residing in memory 774.

At least one of the PROGs 778 in the core network element 770 is assumed to include a set of program instructions that, when executed by the associated DP 772, enable the device to operate in accordance with the exemplary embodiments of this invention, as detailed above. In these regards the exemplary embodiments of this invention may be implemented at least in part by computer software stored on the MEM 774, which is executable by the DP 772 of the core network element 770, or by hardware, or by a combination of tangibly stored software and hardware (and tangibly stored firmware). Similarly, at least one of the PROGs 778 in the core network element 770 is assumed to include a set of program instructions that, when executed by the associated DP 772, enable the device to operate in accordance with the exemplary embodiments of this invention, as detailed above. Electronic devices implementing these aspects of the invention need not be the entire devices as depicted at FIG. 1 or FIG. 6 or may be one or more components of same such as the above described tangibly stored software, hardware, firmware and DP, or a system on a chip SOC or an application specific integrated circuit ASIC.

Various embodiments of the computer readable MEM 774 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 772 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description. It will be further recognized that various blocks discussed above may be performed as steps, but the order in which they are presented is not limiting and they may be performed in any appropriate order with or without additional intervening blocks or steps.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1-38. (canceled)

39. An apparatus comprising:
at least one processor;
memory storing a program of instructions;
wherein the memory storing the program of instructions is configured to, with the at least one processor, cause the apparatus to at least:
in response to receiving a discovery report originating at a discovering user device, wherein the discovery report includes an identifying sequence from a discovering user device, send, to a core network element, discovery information including an identifier of the discovered device; and
receive a notification from the core network element indicating whether the discovery report represents a collision, wherein the notification is based on examination of one or more neighbor cells to a cell serving the discovering user device, and wherein a collision is indicated if at least an identical identifying sequence to that of the discovered device is present in at least one of the one or more neighbor cells.

40. The apparatus of claim 39, wherein the identifying sequence is allocated to a discovered user device by a serving base station of the discovered user device and wherein allocation comprises assigning a period of validity to the sequence, and wherein the discovery information is sent to the core network element only upon confirmation from the base station serving the discovered user device that the base station has allocated the reported sequence to a user device during its period of validity.

41. The apparatus of claim 39, wherein the identifying sequence of the discovered user device is allocated to the discovered user device by its serving base station.

42. The apparatus of claim 41, wherein each serving base station allocating an identifying sequence of a user device provides to the core network entity information relating to the identifying sequence.

43. The apparatus of claim 39, wherein the core network element is a mobility management entity.

44. The apparatus of claim 39, wherein the discovery information is sent to the core network entity over an S1 connection.

45. An apparatus comprising:
at least one processor;
memory storing a program of instructions;
wherein the memory storing the program of instructions is configured to, with the at least one processor, cause the apparatus to at least:
in response to receiving discovery report information from a base station serving a discovering user device, wherein the discovery report includes an identifying sequence of a discovered user device detected by the discovering user device, examine information for cells neighboring the serving base station of the discovering user device to determine if one or more neighbor cells are associated with an identifying sequence identical to that of the discovered user device; and
if one or more neighbor cells are associated with an identifying sequence identical to that of the discovered user device, determine that discovery of the discovered user device has been affected by a collision.

46. The apparatus of claim 45, wherein the apparatus is further caused to reallocate a new identifying sequence to the discovered user device if it is determined that discovery of the discovered user device has been affected by a collision.

47. The apparatus of claim 45, wherein the identifying sequence of the discovered user device comprises a period of validity assigned by the serving base station of the discovered user device and wherein the discovery information is received only if discovery occurs during the period of validity of the sequence.

48. An apparatus comprising:
at least one processor;
memory storing a program of instructions;
wherein the memory storing the program of instructions is configured to, with the at least one processor, cause the apparatus to at least:
control a discovering user device to, upon receiving a discovery beacon from a discovered user device, wherein the discovery beacon comprises an identifying sequence configured to its serving device, wherein the identifying sequence has a specified period of validity, forward a discovery report to a serving base station of the discovering user device;
wherein the discovery report is configured to cause the discovering device's serving base station to forward the discovery report to a core network element which determines whether a collision has occurred based on detection of the identifying sequence in neighboring cells of the serving base station of the discovered user device.

49. The apparatus of claim 48, wherein the discovery report is configured to cause the discovering device's serving base station to forward the discovery report only upon receiving an instruction from the discovered device's serving base station, wherein instruction is sent in response to confirmation by the discovered device's serving base station that the base station has configured the identifying sequence within the validity period.
